(19) United States
(12) Patent Application Publication
(10) Pub. No.: US 2005/0040591 A1
(43) Pub. Date: Feb. 24, 2005

(54) Break open lottery ticket

(76) Inventors: Lyle Harold Scrymgeour, Oakbank Manitoba (CA); Michael John Brickwood, Winnipeg Manitoba (CA)

Correspondence Address: Adrian D Battison;Ade & Company, 1700 360 Main Street, Winnipeg Manitoba, R3C 3Z3, CA

(21) Appl. No.: 10/491,907

(22) PCT Filed: Oct. 23, 2001
(86) PCT No.: PCT/CA01/01390

(51) Int. Cl. A63F 3/06; B42D 15/00

(52) U.S. Cl. 273/138.1; 273/139; 283/903

(57) ABSTRACT

Described herein is a break-open lottery ticket and a method of producing same where the ticket is formed by laminating two substrate sheets. The lottery ticket includes variable imaged lottery indicia printed directly onto the inside surface of one sheet the ticket and covered by a layer of scratch-off material. The indicia and the scratch-off material are covered by a break open window on the other sheet allowing the scratch off material covering the lottery indicia to be exposed for playing the game. The game thus includes two steps of opening the window and removing the scratch-off thus enabling graphic images on the scratch off to be designed relative to the theme of the game to provide an enhanced playing pleasure. The indicia are printed onto a white lily pad in two or more colors allowing a high quality graphic image to be provided to attract the player. Validation numbers can be applied under one larger window.

The present invention relates generally to the field of lottery tickets and particularly to tickets of the break open type which include one or more widows on a first substrate sheet which can be opened to expose lottery game indicia printed on a second substrate sheet laminated to the first.

### BACKGROUND OF THE INVENTION

Lottery tickets are well known and widely sold and typically comprise a sheet material of paper or card stock on which is printed lottery information and various indicia for the playing of one or more games. Many such games are instant win type games where the player can play the game or games by carrying out various functions, for example, opening pull tabs on a break-open ticket. Such tickets are also known variously as pull-tabs, pickle cards, jar tickets, hard cards and charitable gaming tickets.

Break-open tickets are typically constructed by printing a sheet containing multiple combinations of lottery indicia thereon. This sheet is then cut into sections. The opposite side of this sheet includes prize categories, serial number etc. A second sheet contains removable tabs or break-open windows is then mounted onto the card stock such that the break-open windows overlap the lottery indicia. However, break-opens prepared in this manner have the disadvantages that they are cumbersome to prepare, have a limited set of winning symbols and require manually checking at the time of redemption.

U.S. Pat. No. 4,174,857 (Koza) and U.S. Pat. No. 5,253,899 (Greenwood) each disclose a combined ticket construction in which a second layer is applied or folded over the basic ticket to improve security. U.S. Pat. No. 5,562,284 discloses a break-open ticket with a second level of break-open. U.S. Pat. No. 5,217,258 (Sanderson) discloses a two sided break-open ticket where the windows are arranged back to back opening onto a single center sheet carrying the game data.

As shown in published PCT International application No. WO 98/57715 published 23^{rd} Dec. 1998 of the present applicants there is provided a pouched lottery ticket which is supplied in a fan folded continuous strip arrangement for separating each ticket from the next at a dispensing station. The disclosure of this publication may be referred to for further information.

Also in the prior art is a sample of a game ticket manufactured by Scientific Games and known under the trademark “Zip-Tix”. This comprises a ticket formed of a paper back sheet with a foil or metalized front sheet. The front sheet has a single break-open window which can be torn open to reveal a black printed image of game indicia printed onto a grey security coating. The printed image includes a validation number printed under the break-open window so that it is revealed when the window is opened. The game indicia appear to be printed using an ink jet system. What appears to be a validation number is printed below the game data.

In Canadian Patents 2,282,777, 2,282,770 and 2,282,768 all assigned to the present assignee and originally laid open for public inspection on Dec. 5, 1999 are disclosed a number of different constructions of lottery ticket which utilize variable image printing techniques in combination with lamination of two substrate materials together.

### SUMMARY OF THE INVENTION

It is one object of the present invention to provide an improved lottery ticket construction which yet further enhances the pleasure of the player during the playing action leading to the possibility of increased sales and increased profit margin on a premium product.

According to the invention there is provided a lottery ticket construction for playing by a player comprising:
a first substrate sheet material having a front surface and a rear surface;
a second substrate sheet material having a front surface and a rear surface;
promotional graphics printed on said front surface of at least one of the first and second substrate sheets;
lottery game information printed on said front surface of at least one of the first and second substrate sheets;
lottery game indicia printed by variable image printing onto said rear surface of said first substrate sheet;
the lottery game indicia being covered by a layer of scratch-off material removable by the player;
the rear surface of the first substrate sheet being connected to the rear surface of the second substrate sheet to form a ticket;
and at least one openable window on the second substrate sheet arranged such that opening of the window by the player acts to expose the scratch-off material covering the second lottery game indicia on the rear surface of the first strip.

The game thus includes two steps of opening the window and removing the scratch-off thus enabling graphic images on the scratch off to be designed relative to the theme of the game to provide an enhanced playing pleasure.

The variable image printing process as defined above, contrary to the conventional printing press conventionally used for tickets having break open windows, uses a computer controlled system to control conventional printing elements such as ink jet, bubble jet or laser so that the image applied can be varied to any particular requirement allowing each ticket to be entirely different from others.

The above arrangement may allow the scratch-off material to include a printed image as opposed to just a plain layer and this may include different colors. Thus the printed image can be printed with a character which is unconnected with the lottery game indicia so as to provide no indication as to the lottery game indicia covered thereby and can have a character designed relative to the theme of the game to provide an enhanced playing pleasure.

Preferably the window is larger in area than an area of the rear surface of the first substrate sheet covered by the scratch off material and the lottery game indicia so as to expose the whole of the scratch off material when opened.

Preferably there is provided on the rear surface of the first substrate sheet a plurality of separate lottery game indicia elements and wherein the second substrate sheet has a plurality of windows each associated with a respective one of the plurality of elements such that opening of each window acts to expose individually a respective element.

The lottery game elements may be associated together in one or more groups each defining a separate lottery game.

Preferably the lottery indicia on the rear surface of the first substrate sheet includes a variable image number, which may be covered by the scratch off material, for validating the lottery ticket which is exposed by opening one window which may be a larger window designed into the theme and playing format of the game. The variable image number can be in machine readable format or in human readable format or both.

Preferably the lottery game indicia are applied by variable image printing onto a white 111y pad for security reasons as is well known in the art.

### BRIEF DESCRIPTION OF THE DRAWINGS

One embodiment of the invention will now be described in conjunction with the accompanying drawings in which:

FIG. 1 is a front view of one example of lottery ticket according to the present invention showing the front surface of the second or covering sheet.

FIG. 2 is a front view of the lottery ticket of FIG. 1 with some of the break-open windows opened to expose the scratch off material and some of the scratch off material removed to expose the game indicia.

FIG. 3 is a rear view of the lottery ticket of FIG. 1 showing the front surface of the first or rear sheet.

FIG. 4 is a partial transverse cross sectional view of the lottery ticket of FIG. 1.

FIG. 5 is a side view of the card assembly including a continuous connected strip of the cards.

FIG. 6 is a schematic side elevational view of a process for forming the card assembly of FIG. 5.

In the drawings like characters of reference indicate corresponding parts in the different figures.

### DESCRIPTION OF THE PREFERRED EMBODIMENTS

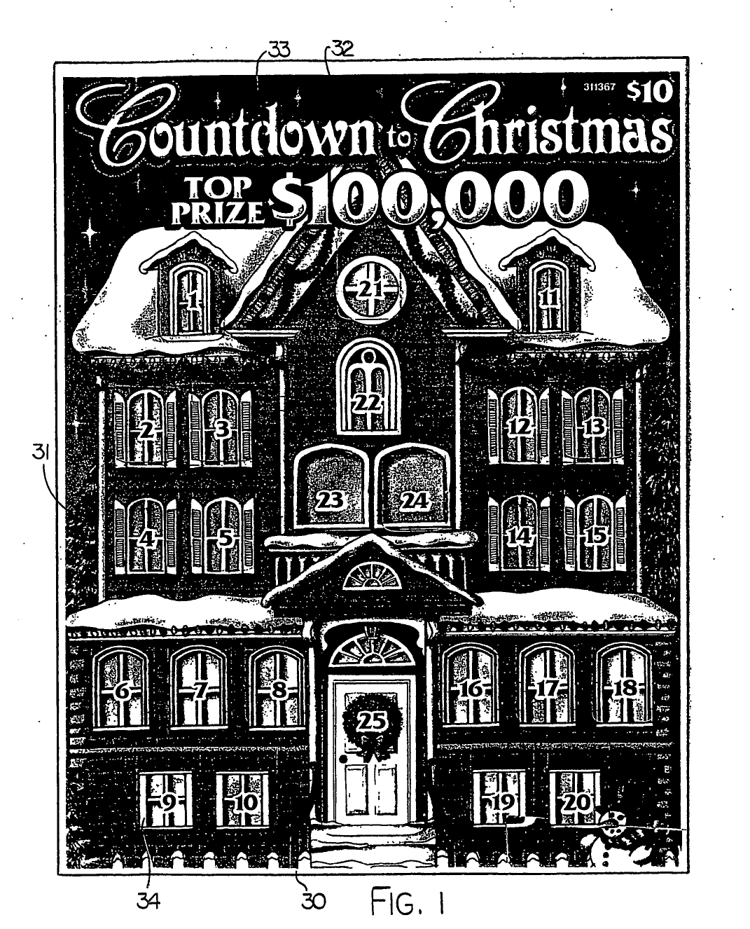

In FIG. 1 is shown a lottery ticket 30 having a front surface carrying printed graphics 31 defining the playable game and including promotional material 32 and game information 33. The game itself in the example shown is the image of a house with a series of windows. Each of the graphically printed windows is formed with a surrounding kiss cut line 34 by which the player can crack open the window and peel up the window breaking the line at the bottom and sides so that the window is attached only at the top.

The example shown is merely one design of game and arrangement of graphics to provide a particular theme and it will be appreciated that many other themes can be generated by persons skilled in this art.

In the embodiment shown the windows are arranged in groups so that there are groups of five windows 1 to 5, 6 to 10, 11 to 15, 16 to 20 and 21 to 25. The windows are of different appearances for an attractive effect. One of the windows 25 is larger than the others and in the graphic arrangement selected forms the door of the house. However the, point of note is that the open of a window itself in the card is of a larger size allowing the presence of additional information to be printed underneath the window.

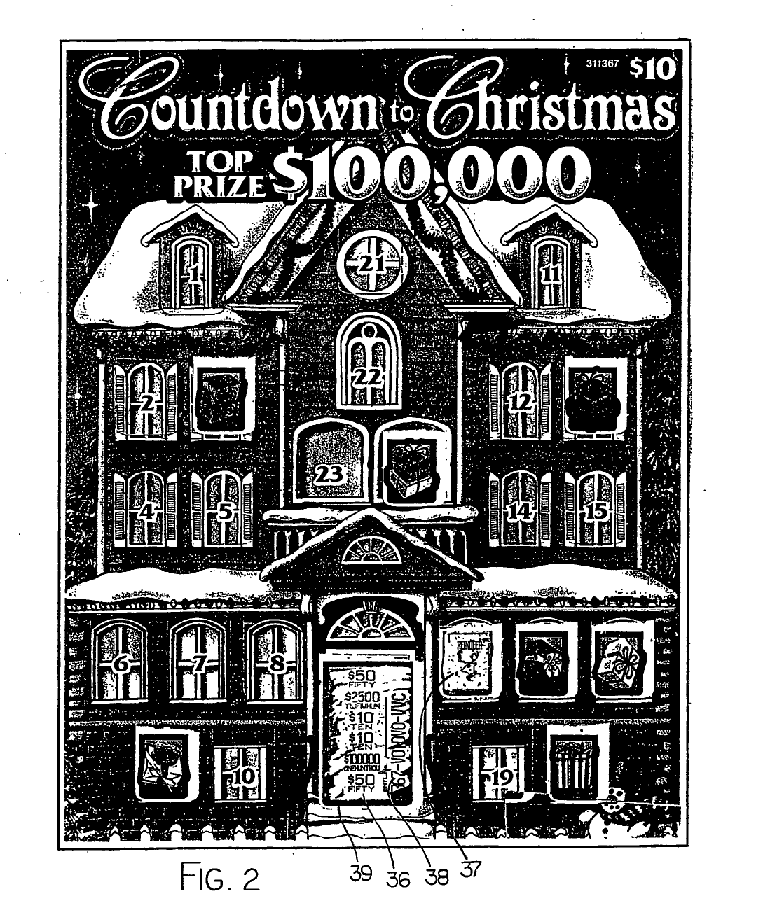

Turning now to FIG. 2 it will be noted that windows 3, 9, 13, 16, 17, 18, 20 and 25 have been opened to expose the rear face of the main or rear substrate behind. The opening of the above windows acts to expose the material printed on the rear face and in windows 3, 9, 13, 16, 17, 18 and 20 there is exposed firstly a layer of scratch off material on which is printed the graphic display of a suitable image. In the example, the image is a present or parcel suitable for the theme of the Christmas house depicted on the ticket. Thus in an initial action the player opens the window selected and is faced by a printed image of an object relevant to the theme concerned which wholly covers and hides the game data or lottery game indicia printed underneath the scratch off material. The presence of this graphic image on the scratch off material provides another layer of playing pleasure for the player relevant to the theme concerned.

The windows 16 and 25 have also been scratched to remove the scratch off coating and the image printed thereon revealing the lottery game indicia 36 and 37 underneath. The lottery game indicia 37 in window 16 comprises a suitable game element playable on a conventional lottery game in which it is required to match certain game elements within groups to provide a winning ticket. It will be appreciated that the group containing windows 16 through 20 would constitute one game in which it is necessary to match the lottery game indicia.

The game indicia 36 under window 25 provides a different type of game in which certain prizes can be won.

In addition under window 25 is provided a validation number or ticket number 38 which can be in human readable or machine readable or in both. The validation number is covered by the scratch off layer which is exposed. It will be further noted that the outside edge 39 of the scratch off layer forms an area within the window 25 so that the whole of the scratch off area is slightly smaller than the window itself and thus is wholly exposed when the window is opened.

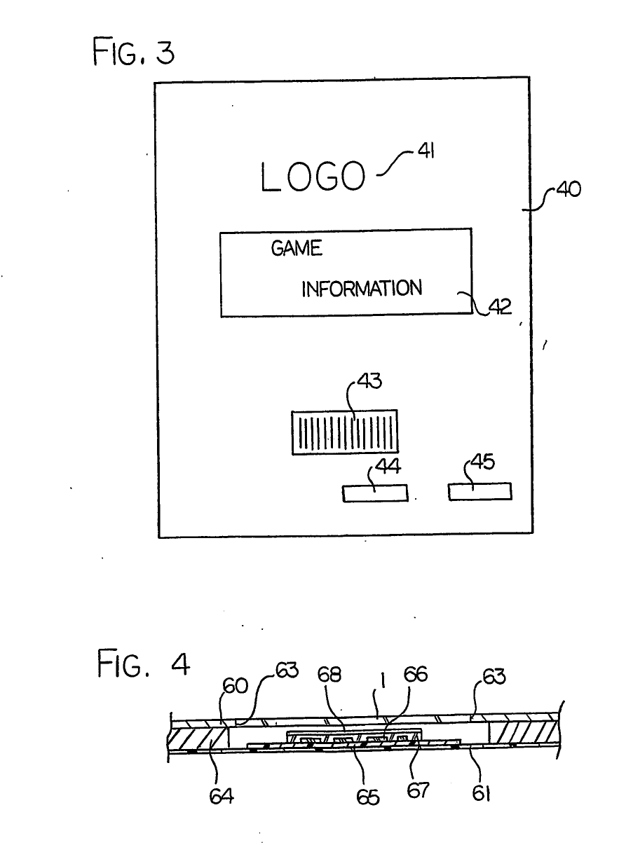

Turning now to FIG. 3, the rear of the ticket is shown as indicated at 40 that is the front surface of the rear or main sheet and includes logo 41, game information or game rules 42, a bar code 43 and other validation numbers 44 and 45.

In FIG. 4 the construction is shown in cross section including the upper or front substrate sheet 60 and the rear or main substrate sheet 61. The window 1 is shown in cross section in the closed position showing the lines of weakness 63 by which the player may crack open the window in conventional manner. The two sheets 60 and 61 are laminated together by adhesive 64 applied in the areas between the windows so that the sheets are attached together substantially across their full extent apart from the location at the windows.

Underneath each window on the rear surface of the sheet 61 is provided a white 111y pad 65 printed onto the rear surface on which is applied by variable image printing the lottery game indicia 66. On top of that is applied the scratch off material 67 of a conventional latex material covered by the graphics image 68 printed onto the latex material for scratch removal therewith.

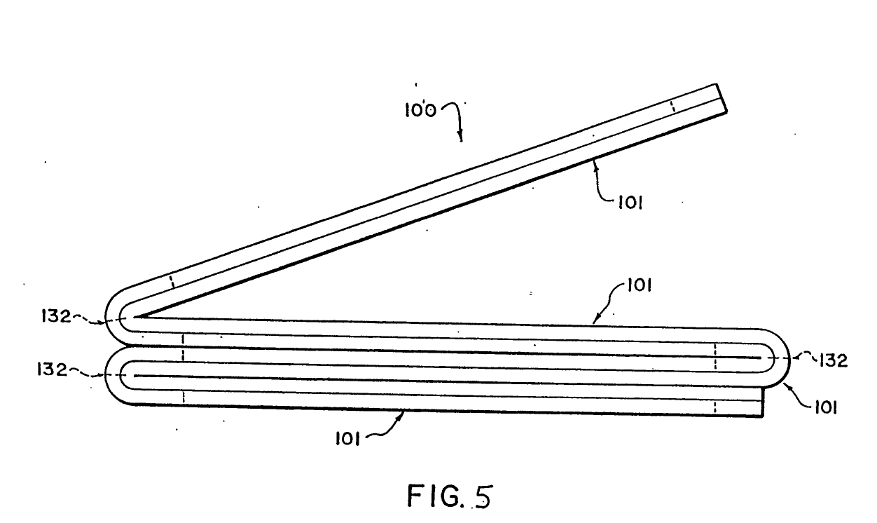

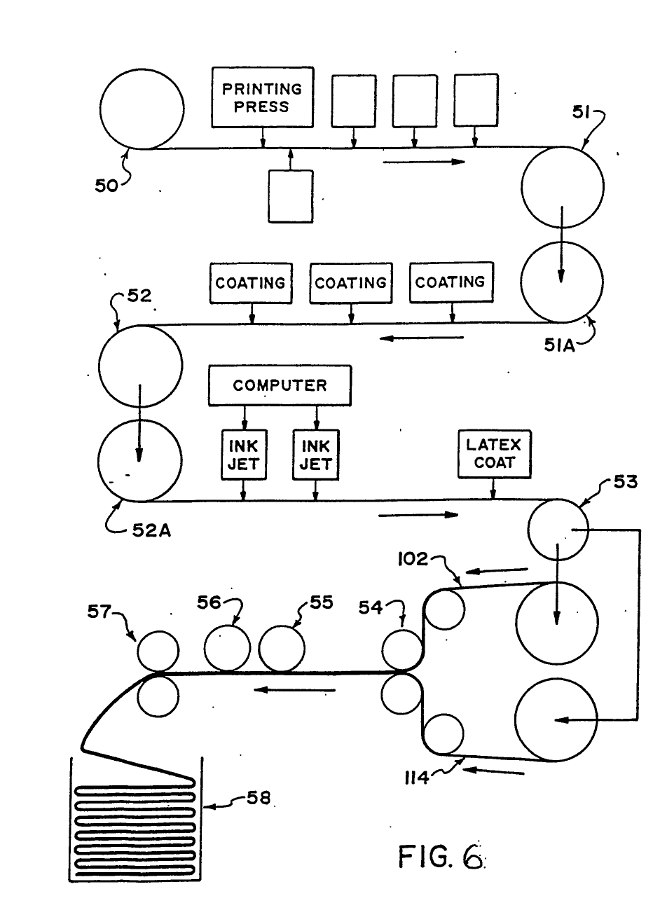

As shown in FIGS. 5 and 6 a method of preparing a card construction 100 comprised of a plurality of cards 101 in a row. A plurality of rows of perforations 132 are introduced into the card construction 100 at junctions between the top edge of a representative one of the plurality of cards 101 and the bottom edge of an adjacent one of the plurality of cards 101. As a result of this arrangement, the plurality of cards 101 can be separated into individual cards by tearing along the rows of perforations 132. The plurality of cards 101 are folded along each of the plurality of rows of perforations 132 with the fold at the front edge of each card being in a direction opposite to the fold at the rear edge of each card so that the cards lie each on top of and parallel to the next, as shown in FIG. 5. The cards can be supplied for sale individually or in the strip as shown. If sold individually, the cards can be cut to be totally separated during manufacture or can be perforated for manual separation.

In FIG. 6 is shown schematically the process described above. The process is shown in a number of discreet steps but it will be appreciated that the process can be integrated into a single continuous production line without the necessity for unrolling and re-rolling the strip in the separate steps as shown.

Thus in a first step of the process, an initial strip of blank paper stock is unrolled from a supply roll 50 and is rewound onto a rewind roll 51. As the strip is forwarded, graphics and base printing is applied onto the strip from a series of colour printing presses so as to provide preferably a full colour printing of both sides of the strip.

In the second step, the re-rolled roll is used as a supply as indicated at 51A and the strip passes through a coating station which may include a plurality of coating elements before being rewound at a rewind station 52. The selection of coatings can be made depending upon the level of security required as well known in the art. Various arrangements of security coating are known in the industry and thus this aspect is well known to one skilled in the art and further detail will not be described in detail herein. The coating elements selected may provide at least one layer or 111y pad over sections of the strip at which the lottery game data is to be applied. This may provide a security layer or coating for the strip which enhances security to prevent chemical, light or other attack onto the base paper stock to avoid improper examination of the cards revealing the lottery game data without the necessity for scratching the scratch off layers.

The resultant or final layer of the security coating is generally a white 111y pad so that the white layer does not interfere with or detract from the brightness of subsequent application of coloured printed materials or layers.

The re-rolled roll 52 is applied at a supply station 52A for a third step in the process where the strip is unrolled and re-rolled at a station 53. In the third step, the lottery game data applied to the white 111y pad over the security layers previously described. The lottery game data is applied by variable image printing techniques such as ink jet as opposed to use of fixed printing presses.

The application of a bar code (including machine and/or human readable portions) which is unique to the card and is applied directly with and at the same time as the lottery game data to allow identification and tracking of individual cards. The bar code may be located either under a window or on the outside or exposed surface of the bottom or rear sheet.

Subsequent to the application of the lottery game data a coating device applies the latex scratch-off coating in one or more layers including the printed graphics or image layer using conventional techniques and materials. The coated strip is then wound at a winding station 53. Although it is shown for convenience that the latex coating is in line with the imaging, this is generally not so and the two steps are carried out independently on different lines.

Strips thus formed with the graphics printing, security coatings, lottery game data and scratch-off layers are thus formed and available at the station 53. Two of these strips each having the respective printed elements described above, where one strip carries the lottery game data and scratch off material, and printed with different data are then used in a lamination process at laminating and calendar rolls 54. The laminated strips are then passed through a die cut roller system 55 and a kiss cut roller system 56 to apply the lines of weakness for the windows and perforations as previously described. The strip is then folded back and forth in a fan folding arrangement 57 to form a fan folded stack 58 of the finished cards in the card assembly.

The lottery indicia are applied by variable image printing techniques as opposed to use of fixed printing presses. It will be appreciated that a printing press can apply only predetermined arrangements of characters which are set up in the printing press and cannot be readily or quickly varied. The variable image printing process to the contrary uses a computer controlled system to control conventional printing elements such as Ink Jet, bubble jet or laser so that the image applied can be varied to any particular requirement allowing each ticket to be entirely different from others. This technique can generate one color images, but more preferably two colors such as red and black or more color images

The use of variable image printing techniques allows also the following advantages:

It avoids the use of a limited number of combinations of symbols in the game data which is otherwise available by conventional printing press.

The prize parameters, that is the arrangement and numbers of winning tickets relative to losing tickets, can be tailored to suit particular circumstances, customers or games and is not limited to the fixed arrangements available with the conventional printing press.

As the strip is continuous and is not cut from a press printed sheet, there are no markings or patterning of the substrate caused by mechanically cutting substrate pieces from a larger printed sheet, thus avoiding the possibility that the markings or patterning could be used to locate and identify winning tickets.

The application of a bar code (including machine and/or human readable portions) which is unique to the ticket and is applied directly with and at the same time as the game indicia to allow identification and validation of individual tickets.

While the preferred embodiments of the invention have been described above, it will be recognized and understood that various modifications may be made therein, and the appended claims are intended to cover all such modifications which may fall within the spirit and scope of the invention.

1. A lottery ticket construction for playing by a player comprising:
a first substrate sheet material having a front surface and a rear surface;
a second substrate sheet material having a front surface and a rear surface;
the rear surface of the first substrate sheet being connected to the rear surface of the second substrate sheet to form a ticket;
promotional graphics printed on said front surface of at least one of the first and second substrate sheets;
lottery game information printed on said front surface of at least one of the first and second substrate sheets;
the promotional graphics and the lottery game information being arranged to define a game theme;
a plurality of openable windows on the second substrate sheet arranged such that opening of each window by the player acts to expose a respective area on the rear surface of the first substrate sheet:
each respective area of the rear surface of the first substrate sheet having lottery game indicia printed thereon;
the lottery game indicia being printed by variable image printing onto said rear surface of said first substrate sheet;
the lottery game indicia on each of said respective areas being covered by a layer of scratch-off material removable by the player;
wherein the scratch-off material of at least some of said respective areas includes a printed image thereon related to the game theme defined by the promotional graphics and the lottery game information.

2. (cancelled).

3. The lottery ticket construction according to claim 1 wherein the printed image includes different colors.

4. The lottery ticket construction according to claim 2 wherein the printed image has a character which is unconnected with the lottery game indicia so as to provide no indication as to the lottery game indicia covered thereby.

5. The lottery ticket construction according to claim 1, wherein the window is larger in area than an area of the rear surface of the first substrate sheet covered by the scratch off material and the lottery game indicia so as to expose the whole of the scratch off material when opened.

6. (Cancelled)

7. (Cancelled)

8. (Cancelled)

9. (Cancelled)

10. The lottery ticket construction according to claim 1 wherein the lottery indicia on the rear surface of the first substrate sheet includes a variable image number for validating the lottery ticket which is exposed by opening the respective window.

11. The lottery ticket construction according to claim 10 wherein the respective window is larger than the other windows.

12. The lottery ticket construction according to claim 10 wherein the variable image number is covered by the scratch off material.

13. (Cancelled)

14. (Cancelled)

15. A lottery ticket construction for playing by a player comprising:
a first continuous substrate sheet material in a first strip having a front surface and a rear surface;
a second continuous substrate sheet material in a second strip having a front surface and a rear surface;
the rear surface of the first strip being connected to the rear surface of the second strip to form a row of connected tickets;
the first and second strips having a line of weakness between each ticket and the next for separation of each ticket from the next;
each ticket having promotional graphics printed on said front surface of at least one of the first and second strips;
each ticket having lottery game information printed on said front surface of at least one of the first and second strips;
each ticket having lottery game indicia printed by variable image printing onto said rear surface of said first strip;
each ticket having the lottery game indicia being covered by a layer of scratch-off material removable by the player;
and each ticket having at least one openable window on the second strip arranged such that opening of the window by the player acts to expose the scratch-off material covering the second lottery game indicia on the rear surface of the first strip.

16. The lottery ticket construction according to claim 15 wherein the lottery tickets are fan folded along each junction with the fold at the front edge of each lottery ticket construction being in a direction opposite to the fold at the rear edge of each lottery ticket construction so that the tickets lie each on top of and parallel to the next.

17. The lottery ticket construction according to claim 15 wherein the scratch-off material includes a printed image.

18. The lottery ticket construction according to claim 17 wherein the printed image includes different colors.

19. The lottery ticket construction according to claim 17 wherein the printed image has a character which is unconnected with the lottery game indicia so as to provide no indication as to the lottery game indicia covered thereby.

20. The lottery ticket construction according to claim 15 wherein the window is larger in area than an area of the rear surface of the first substrate sheet covered by the scratch off material and the lottery game indicia so as to expose the whole of the scratch off material when opened.

21. The lottery ticket construction according to claim 15 wherein there is provided on the rear surface of the first substrate sheet a plurality of separate lottery game indicia elements and wherein the second substrate sheet has a plurality of windows each associated with a respective one of the plurality of elements such that opening of each window acts to expose individually a respective element.

22. The lottery ticket construction according to claim 21 wherein the lottery game elements are associated together in at least one group defining a lottery game.

23. The lottery ticket construction according to claim 21 wherein the lottery game elements are associated together in a plurality of groups with each group defining a separate lottery game.

24. The lottery ticket construction according to claim 15 wherein the lottery indicia on the rear surface of the first substrate sheet includes a variable image number for validating the lottery ticket which is exposed by opening said at least one window.

25. The lottery ticket construction according to claim 24 wherein one element of the lottery indicia on the rear surface of the first substrate sheet includes a variable image number for validating the lottery ticket which is exposed by opening the respective window.

26. The lottery ticket construction according to claim 25 wherein the respective window is larger than the other windows.

27. The lottery ticket construction according to claim 25 wherein the variable image number is covered by the scratch off material.

28. The lottery ticket construction according to claim 15 wherein the lottery game indicia are applied by variable image printing onto a white 111y pad.

29. The lottery ticket construction according to claim 15 wherein the lottery game indicia are applied by variable image printing using two or more colors.

30. A lottery ticket construction for playing by a player comprising:
a first continuous substrate sheet material in a first strip having a front surface and a rear surface;
a second continuous substrate sheet material in a second strip having a front surface and a rear surface;
the rear surface of the first strip being connected to the rear surface of the second strip to form a row of connected tickets;
the first and second strips having a line of weakness between each ticket and the next for separation of each ticket from the next;
each ticket having promotional graphics printed on said front surface of at least one of the first and second substrate sheets;
each ticket having lottery game information printed on said front surface of at least one of the first and second substrate sheets;
the promotional graphics and the lottery game information being arranged to define a game theme;
each ticket having a plurality of openable windows on the second substrate sheet arranged such that opening of each window by the player acts to expose a respective area on the rear surface of the first substrate sheet;
each respective area of the rear surface of the first substrate sheet of each ticket having lottery game indicia printed thereon;
the lottery game indicia being printed by variable image printing onto said rear surface of said first substrate sheet;
the lottery game indicia on each of said respective areas of each ticket being covered by a layer of scratch-off material removable by the player;
wherein the scratch-off material of at least some of said respective areas of each ticket includes a printed image thereon related to the game theme defined by the promotional graphics and the lottery game information.

31. The lottery ticket construction according to claim 30 wherein the printed image includes different colors.

32. The lottery ticket construction according to claim 30 wherein the printed image has a character which is unconnected with the lottery game indicia so as to provide no indication as to the lottery game indicia covered thereby.

33. The lottery ticket construction according to claim 30 wherein the window is larger in area than an area of the rear surface of the first substrate sheet covered by the scratch off material and the lottery game indicia so as to expose the whole of the scratch off material when opened.

34. The lottery ticket construction according to claim 30 wherein the lottery indicia on the rear surface of the first substrate sheet includes a variable image number for validating the lottery ticket which is exposed by opening one respective window of said plurality of windows.

35. The lottery ticket construction according to claim 30 wherein the respective window is larger than the other windows.

36. The lottery ticket construction according to claim 30 wherein the variable image number is covered by the scratch off material.
